(19) United States
(12) Patent Application Publication
(10) Pub. No.: US 2013/0101115 A1
(43) Pub. Date: Apr. 25, 2013

(54) METHOD, APPARATUS, AND SYSTEM FOR PROCESSING AND DELIVERING MEDIA CONTENT

(71) Applicant: Ad Khamkhosy, Happy Valley, OR (US)

(72) Inventor: Ad Khamkhosy, Happy Valley, OR (US)

(73) Assignee: PLAYNSITE, LLC, Happy Valley, OR (US)

(21) Appl. No.: 13/277,007

(22) Filed: Oct. 19, 2011

(51) Int. Cl. H04N 7/167

(52) U.S. Cl. 380/201

(57) ABSTRACT

A method for facilitating the live broadcast of special events includes receiving an equipment rental request, dispatching the equipment including a live media transmitter, receiving a live digital video transmission from the live media transmitter, watermarking the live digital video transmission, and transmitting the live digital stream. A method includes initiating a video conference between a media content coordinator and a media content owner, thereby memorializing a media content distribution agreement, including a record of the conference and electronic signatures formalizing the agreement. A user interface includes a rotatable globe for selecting a country or region of interest to access digital media content from the area of interest. A live media transmitter 135 includes multiple wireless transmitters for transmitting a live media content stream, and provides load-balancing and fail-safe capabilities. The methods and apparatus can be operated in connection with a media content distribution system.

### TECHNICAL FIELD

This disclosure relates to digital media, and, more particularly, to a method, apparatus, and system for processing and delivering digital media content.

### BACKGROUND

In the latter part of the twentieth century and the beginning of the twenty first century, digital media began to proliferate. Traditional analog forms of broadcast media gave way to more sophisticated digital transmissions. Digital flat-panel televisions with much higher picture quality rapidly replaced the more bulky lower-quality analog television sets. Mobile devices, once used only for paging or telephone service, were developed into smart computing devices capable of wirelessly transmitting and receiving digital images including digital video content.

During this transition, access to digital media content greatly expanded. Cable television companies began offering a suite of digital channels, high-definition line-ups, and the like. Satellite television companies quickly did the same. Some traditional telephone companies expanded into the digital media home market by enabling digital television transmissions over fiber optic cables routed to private homes. In the meanwhile, computer and Internet speeds advanced at such a rapid pace that watching high-quality television broadcasts using an average computer and network connection became possible.

However, while myriad choices, both in terms of the types of access to the content and to the content itself, are presented to consumers of digital media, the reality is that few original works find a suitable distribution outlet with any significant level of exposure. For example, of the 1,100 estimated independent films produced in 2011, only 150-170 were expected to find distribution, with only about 20 of those finding significant exposure.

More recently, subscriptions to cable and satellite television services have started to decline, thereby limiting some of the more traditional distribution outlets. Other “special events” such as conventions, weddings, news worthy events, and the like, rarely if ever are broadcast to otherwise interested individuals who might derive enjoyment in watching such events as they happen live. Conventional broadcast equipment is generally too expensive and too technically complex to use in smaller special event venues. Moreover, there is currently no central location where one can go to gain access to all content that might be of interest.

These are only a few of the challenges presented by conventional approaches, which are impeding wider access to electronically broadcasted digital media content. Accordingly, a need remains for an improved method, apparatus, and system for processing and distributing digital media content. More specifically, a need remains for improving the interactions between content creators and content distributors, facilitating the production and distribution of independent films and other special events, and providing a central location for access to live or previously recorded events. Embodiments of the invention address these and other limitations in the prior art.

### BRIEF DESCRIPTION OF THE DRAWINGS

FIG. 1 illustrates a flow diagram including components used in coordinating and delivering digital media content according to an example embodiment of the present invention.

FIG. 2 illustrates a continuation of the flow diagram of FIG. 2, including additional components used in coordinating and delivering the digital media content.

FIG. 3 illustrates a diagram including components used in memorializing a digital media content distribution agreement according to another example embodiment of the present invention.

FIG. 4 illustrates a flow diagram including a technique for memorializing the digital media content distribution agreement of FIG. 3.

FIG. 5 illustrates a flow diagram including components used in coordinating and delivering digital media content according to yet another example embodiment of the present invention.

FIG. 6 illustrates a block diagram including a web browser having a user interface configured for pause and shop functionality according to still another example embodiment of the present invention.

FIG. 7 illustrates a flow diagram including a technique for pausing the digital media content stream, and shopping for associated articles of FIG. 6.

The foregoing and other features of the invention will become more readily apparent from the following detailed description, which proceeds with reference to the accompanying drawings.

### DETAILED DESCRIPTION

Reference will now be made in detail to embodiments of the invention, examples of which are illustrated in the accompanying drawings. In the following detailed description, numerous specific details are set forth to enable a thorough understanding of the present invention. It should be understood, however, that persons having ordinary skill in the art may practice the present invention without these specific details. In other instances, well-known methods, procedures, components, circuits, and networks have not been described in detail so as not to unnecessarily obscure aspects of the embodiments.

It will be understood that, although the terms first, second, etc. may be used herein to describe various elements, these elements should not be limited by these terms. These terms are only used to distinguish one element from another. For example, a first interface window could be termed a second interface window, and, similarly, a second interface window could be termed a first interface window, without departing from the scope of the present invention.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of an apparatus and method for processing and delivering digital media content, user interfaces for such apparatus and method, associated processes for using such apparatus, and associated systems with which such apparatus and method can be used, are described.

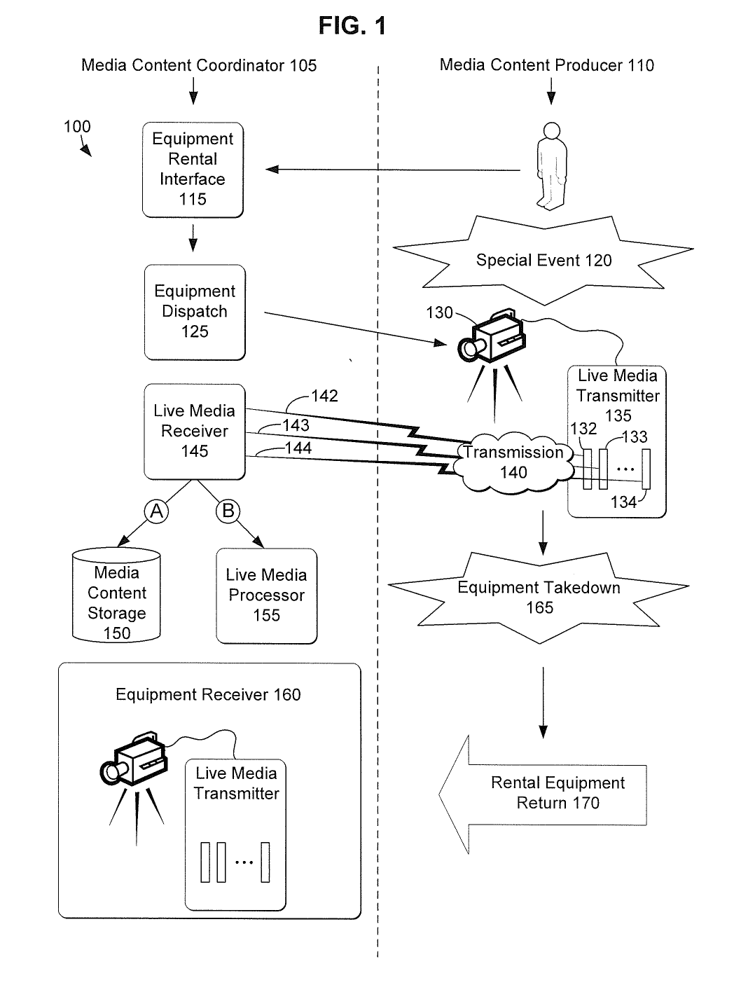

FIG. 1 illustrates a flow diagram 100 including components used in coordinating and delivering digital media content according to an example embodiment of the present invention. A media content coordinator 105 provides an equipment rental interface 115 for renting digital media related equipment for use in facilitating live broadcast of special events. The digital media related equipment can include, for example, a digital video camera 130 and/or a live media transmitter 135. It will be understood that the equipment can include other suitable parts that relate to the production of digital media such as cables, lighting equipment, tripods, makeup, batter backup units, or the like. The equipment rental interface 115 can include a web page having a user interface for receiving the rental request. Alternatively, the equipment rental interface 115 can include an automated telephone system, live operators, email communications, or the like.

A media content producer 110 sends an equipment rental request to the media content coordinator 105 through the equipment rental interface 115. The media content producer 110 can specify in the request which parts of the equipment are needed and for how long. The media content coordinator 105 receives and processes the rental request. A rental agreement can be completed as between the media content producer 110 and the media content coordinator 105 through the interface 115. It will be understood that the media content producer 110 can correspond to the person or entity responsible for operating the special event 120, the owner of the digital media content itself, and/or a third party person or organization hired to participate in producing and/or broadcasting the special event 120. It will also be understood that the media content coordinator 105 and the media content producer 110 can be the same person or entity, and in such case, the rental agreement relationship need not be established. In some embodiments, the special event 120 is a live special event. The live special event can include, for example, a business conference, a private wedding, a concert, a battle of the bands, a party, a protest, a natural disaster, a historic discovery, a public gathering, or any other suitable public or private event.

After receiving the rental request through the equipment rental interface 115, the media content coordinator 105 can dispatch the equipment through the equipment dispatch 125 to the media content producer 110. The equipment dispatch 125 can include an unloading dock, a delivery truck, a means for tracking the equipment, or the like. As mentioned above, the equipment can include a digital video camera 130, such as a high-definition digital video camera, which can be coupled to a live media transmitter 135.

The live media transmitter 135 can include, among other components, a plurality of wireless transmitters (e.g., 132, 133, and 134). Each of the wireless transmitters can correspond to, for example, a cellular transmitter that is configured to transmit digital data over a cellular network. The wireless transmitters can correspond to third generation (3G) transceivers, fourth generation (4G) cellular transceivers, satellite transceivers, or any other suitable long-range wireless transceivers.

A live media receiver 145 can wirelessly receive a live digital video transmission 140 from the live media transmitter 135, irrespective of the location of the live media transmitter 135. Because high-quality digital transmissions, such as 1080 progressive (1080P) high definition digital video, occupy significant amounts of bandwidth, multiple wireless transmitters can be simultaneously used in combination to meet the bandwidth needs of a live high-quality media content transmission.

In other words, the live media receiver 145 can receive a first portion 142 of the live digital media transmission 140, which can be transmitted by a first wireless transmitter 132 of the live media transmitter 135. It should be understood that the digital media transmission 140 can include digital video, audio, or any other suitable still or moving pictures. In addition, the digital media transmission 140 is preferably encrypted by the live media transmitter 135 prior to transmission. Simultaneous to receiving the first portion 142, the live media receiver 145 can receive a second portion 143 of the live digital media transmission 140, which can be transmitted by a second wireless transmitter 133 of the live media transmitter 135.

Moreover, simultaneous to receiving the first portion 142 and the second portion 143, the live media receiver 145 can receive a third portion 144 of the live digital media transmission 140, which can be transmitted by a third wireless transmitter 134 of the live media transmitter 135. It should be understood that four or more wireless transmitters can be used depending on the wireless bandwidth needs to sufficiently support the transmission of a high-quality live broadcast signal.

While the live media receiver 145 is receiving the different portions of the live digital media transmission 140, the live media receiver 145 can combine the various portions into a single coherent live stream. In other words, the constituent portions of the live digital media transmission 140 can be recombined into a single coherent digital media transmission or stream, that when displayed, is coherent and viewable.

In addition to load-balancing and enhancing the bandwidth capabilities of the live media transmitter 135, the wireless transmitters (e.g., 132, 133, and 134) can be used to provide robust operational up-time. In other words, the live media transmitter 135 can detect a failure of one of the wireless transmitters and continue to broadcast the digital media stream using the remaining operational wireless transmitters. For example, after detecting a failure condition of one of the wireless transmitters of the live media transmitter 135, in this case, the first wireless transmitter 132, then the live media transmitter 135 can transmit the first portion 142 of the live digital media transmission 140, the second portion 143 of the live digital media transmission 140, and the third portion 144 of the live digital media transmission 140, using the other two operational wireless transmitters, in this case, the wireless transmitters 133 and 134.

In this manner, there is an uninterrupted flow of digital media content being transmitted from the live media transmitter 135 to the live media receiver 145. The live media receiver 145 can therefore receive the corresponding first portion 142, second portion 143, and third portion 144 of the live digital media transmission 140 even when there are failures of the individual components.

During and/or after receiving the live digital media transmission 140, the live media receiver 145 can store the received digital media content to a storage device 150, which can be any suitable volatile storage such as memory or non-volatile permanent storage such as magnetic disk drives or optical drives. The live media receiver 145 can also process the live media using the live media processor 155, which is described in further detail below.

After completion of the live special event, the equipment is taken down at 165 and then is returned at 170. The equipment receiver 160 receives the returned rental equipment, including the digital video camera 130 and the live media transmitter 135, and the account can be settled between the media content coordinator 105 and the media content producer 110.

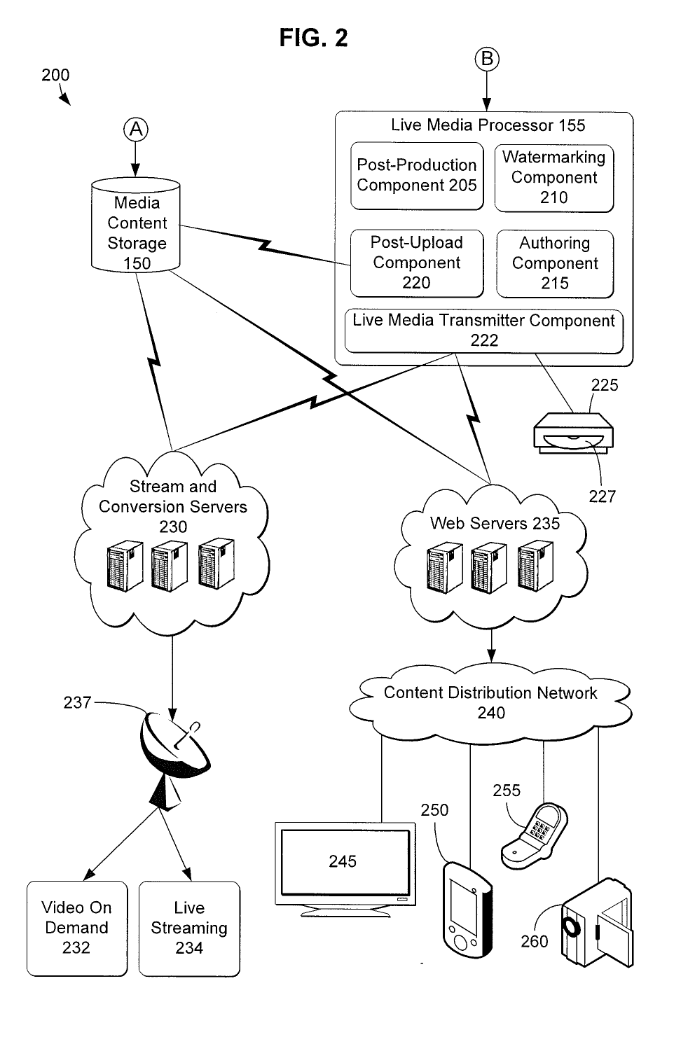

FIG. 2 illustrates a flow diagram 200, which is a continuation of the flow diagram 100 of FIG. 2, including additional components used in coordinating and delivering the digital media content.

The media processor 155 can perform various processing operations on the live digital video transmission. For example, the watermarking component 210 can apply a digital watermark to the live digital video transmission. The watermark can identify or authenticate the source and/or ownership of the digital media content. In addition, the watermark can identify or authenticate other persons or entities such as the media content coordinator 105. The watermark can be visible in the digital video stream. Alternatively, the watermark can be invisible, audible, or otherwise hidden in the digital media content. The watermarking component 210 can add the digital watermark in real-time without interrupting the live transmission.

The live media transmitter component 222 of the live media processor 155 can forward or otherwise transmit the live digital media transmission to one or more web servers 235. Either the live media receiver 145 or the live media processor 155 can decrypt the live digital media transmission prior to transmitting the live digital media transmission to the one or more web servers 235. Alternatively, the live digital media transmission can be decrypted by the one or more web servers 235.

The live media transmitter can also include a post-production component 205, which can modify or supplement the live digital media transmission with special effects, transitions, graphics, fades, wipes, and the like. The authoring component 215 can be used to create new media content, which can be combined with the live digital media transmission. The post-upload component 220 can be used to transfer a copy of the live digital media transmission, in its original form, or with the additional watermarking, post-production, and/or authoring combinations to the media content storage 150. In addition, a copy of the live digital media transmission, in its original form, or with the additional watermarking, post-production, and/or authoring combinations, can be stored to an optical disk 227 using optical disk writer 225.

The one or more web servers 235 can broadcast or otherwise distribute the live digital media transmission to one or more digital media enabled devices such as computer display 245, personal digital assistant 250, cell phone 255, camera 260, or other suitable electronic devices capable of receiving a digital media stream. In some embodiments, the live digital media transmission is broadcasted or distributed using a content distribution network 240, which can be a cloud-based computing platform.

In some embodiments, the copy of the live digital media transmission that is stored to the media content storage 150, can then be transmitted to the one or more web servers 235 for broadcast or other distribution to the digital media enabled devices at a time after the live special event has ended.

In some embodiments, the live digital media stream can be transmitted to one or more stream and conversion servers 230, from either the media content storage 150 or the live media transmitter component 222. From there, the live digital media transmission can be sent over a satellite 237 and associated satellite systems. For video on demand 232, the digital media stream is received from the media content storage 150. For live coverage or live streaming 234, the live digital media transmission is received from the live media transmitter component 222.

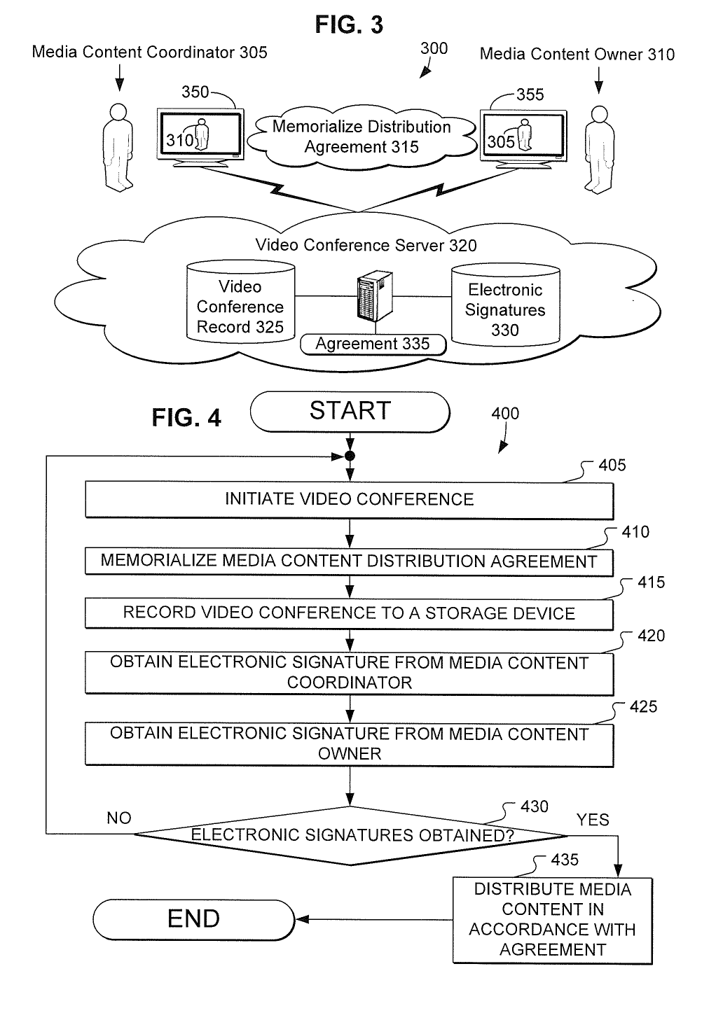

FIG. 3 illustrates a diagram 300 including components used in memorializing 315 a digital media content distribution agreement 335 according to another example embodiment of the present invention.

One of the problems facing the media industry is one of ownership. Disputes over who owns what media content and which rights belong to whom are commonplace. To facilitate an efficient and reliable means for establishing clear interests and rights in connection with the digital media content, the diagram 300 of FIG. 3 sets forth an embodiment of the invention for overcoming such problems in the prior art. A video conference is initiated between a media content coordinator 305 and a media content owner 310. It should be understood that these can be individuals or entities, and “media content owner 310” can specifically refer to an individual or entity having an ownership interest in one or more rights associated with the digital media content.

The video conference server 320 can be used to establish the video conference between the parties. In this manner, the media content coordinator 305 views the media content owner 310 on display screen 350 while the media content owner 310 views the media content coordinator 305 on a different display screen 355. A discussion can ensue to memorialize a distribution agreement 335, which is an agreement that can set forth the contractual obligations of the parties with respect to the distribution of digital media content.

The video conference can be recorded to a storage device as the video conference record 325. In other words, the video conference between the media content coordinator 305 and the media content owner 310 discussing the media content distribution agreement 335 can be recorded to storage. The storage can be separate from or part of the video conference server 320. In addition, a first electronic signature can be obtained from the media content coordinator 305 authorizing the media content distribution agreement 335. Similarly, a second electronic signature can be obtained from the media content owner 310 authorizing the same media content distribution agreement 335. The first and second electronic signatures 330 can be stored to a storage device that is separate from or part of the video conference server 320. In this manner, multiple records are stored, such as the video conference record 325, the electronic signatures 330, and the distribution agreement 335 itself, which can be used to resolve any possible future dispute.

FIG. 4 illustrates a flow diagram 400 including a technique for memorializing the digital media content distribution agreement of FIG. 3. At 405, the video conference is initiated. At 410, the media content distribution agreement is discussed among the media content coordinator 305 and the media content owner 310, and is memorialized. The steps for memorializing can correspond, for example, to steps 415, 420, 425, and 430. At 415, the video conference is recorded to a storage device. At 420, an electronic signature is obtained from the media content coordinator, and stored. At 425, an electronic signature is obtained from the media content owner 310, and stored. At 430, a determination is made whether the electronic signatures have been obtained, stored, and signify the intention of the parties to enter into the digital media distribution agreement 335. If NO, the flow returns to 405. Otherwise, if YES, the flow proceeds to 435 and the digital media content is distributed in accordance with the agreement. It will also be understood that the steps described in these techniques need not necessarily occur in the order as illustrated.

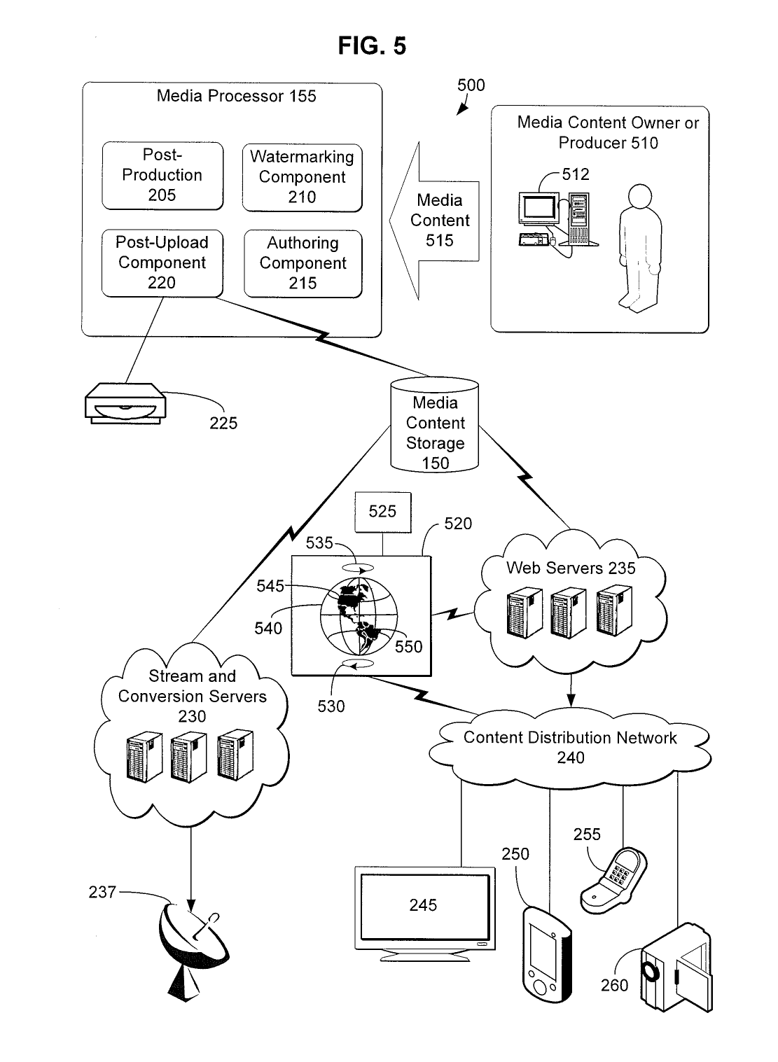

FIG. 5 illustrates a flow diagram 500 including components used in coordinating and delivering digital media content according to yet another example embodiment of the present invention.

Here, the digital media content is not necessarily associated with a live event. Rather, the media content owner or producer 510 possesses digital media content that is to be distributed in accordance to a prearranged agreement. As such, when the media content owner or producer 510 is ready to proceed, the digital media content 515 is uploaded or otherwise transmitted to the media processor 155. For example, the media content 515 can be uploaded to the media processor 155 using the computer 512 or other suitable electronic device.

The media processor 155 and media content storage 150 are similar to or the same as those discussed above, and include many of the same components such as the watermarking component 210, the post-production component 205, the authoring component 215, the post-upload component 220, and the optical disk writer 225. A detailed description of these is not repeated for the sake of brevity. It will be understood, however, that these components can be applied to or otherwise operated in connection with the media content 515 received from the media content owner or producer 510 rather than from a live digital media stream.

Before distributing the digital media content, the watermarking component 210 can insert a digital watermark in the digital media content. Moreover, the watermarked digital media content can be categorized into one of a plurality of categories, each category corresponding to a country or region of the world in which the digital media content originated or is otherwise targeted. The categorization information can be embedded in the digital media content. The watermarked and categorized digital media content can be stored to a storage device such as the media content storage 150.

The digital media content 515, either unmodified or modified by one or more of the components of the media processor 155, can be transmitted to the one or more web servers 235, the content distribution network 240, the digital media enabled devices (e.g., 245, 250, 255, and 260), the stream and conversion servers 230, the satellite 237 and associated systems, and so forth. A detailed description of how the digital media can be transferred between these devices and systems is discussed above and while applicable to this example embodiment, is not repeated here for the sake of brevity.

A user interface 520 can be provided for use with a web browser. The web browser can operate on or be associated with one of the digital media enabled devices (e.g., 245, 250, 255, and 260). In some embodiments, the user interface 520 is provided by the one or more web servers 235. The user interface 520 can include a rotatable globe 540, which can be divided into countries or regions (e.g., 545, 550). The countries or regions can correspond to the plurality of categories. A single region can include one or more countries. Conversely, a single country can include one or more regions.

The one or more web servers 235 can receive input from the web browser or the user interface corresponding to a selection to rotate the globe. Such indication can be by virtue of a click and drag motion, a swipe, or any other suitable motion or method for indicating a desire to rotate the globe by the user of the web browser. The globe can be rotatable in any direction, but is preferably rotatable in only two directions along an axis as indicated by 535 and 530.

After locating a country or region of interest, the user can select the country or region of interest by clicking on it or by any other suitable means. Thus, the one or more web servers 235 can receive input from the web browser indicating a selection of one of the countries or regions of the rotatable globe. After receiving such input, the one or more web servers 235 can match the selected country or region with the corresponding category. Thereafter, a list of digital media content 525 can be displayed in the user interface or in connection with the user interface 520. The list of digital media content 525 corresponds to or is otherwise associated with the matched category.

After the list of digital media content 525 is displayed, the one or more web servers 235 can receive input from the web browser corresponding to a selection of a particular digital media content or title from the list. The particular digital media content or title can correspond to a movie, an independent film, a live streaming special event, a pre-recorded special event, an advertisement, a viral video, an audio sample, and/or any other possible digital media content. The digital media content can be streamed or otherwise distributed in accordance with the various individual distribution agreements such as 335 (of FIG. 3). In other words, each of the digital media files to be distributed can have an associated distribution agreement 335.

The user of the user interface 520 can select a new country or region (e.g., 545, 550) at any time during or after the streaming of a current digital media transmission. In this manner, a three dimensional world-wide “television” guide is provided to the user through a single web-browser based interface.

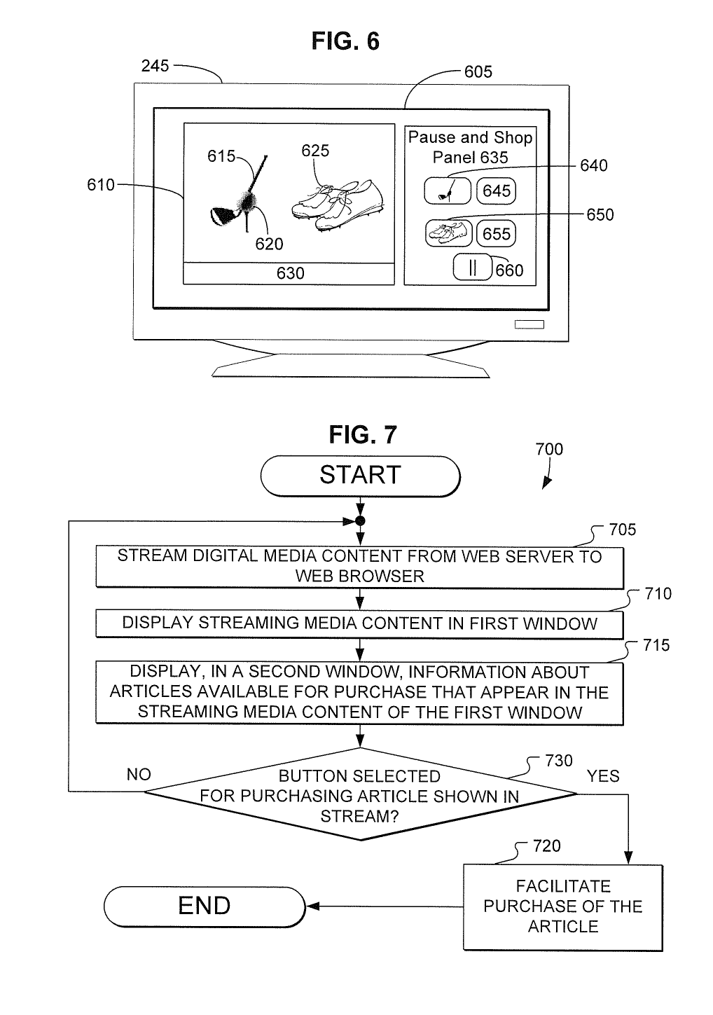

FIG. 6 illustrates a block diagram including a web browser 605 associated with a computer display device 245. The web browser 605 includes a user interface having various windows, and which is configured for “pause and shop” functionality according to still another example embodiment of the present invention.

Window 610 of the user interface can be used for streaming the digital media content. Proximately located to window 610, window 630 is used for displaying information about one or more articles (e.g., golf club 615, golf ball 620, and golf shoes 625) available for purchase that appear in the streaming digital media content of the first window. For example, if a close-up shot of a famous golf player was part of the digital media content being streamed to window 610, information such as brand, price, and/or features of the famous golf player's club, balls, or shoes can be displayed in window 630.

These of course, are just examples, and the inventive concept can apply to any streaming digital media content that contains images of saleable products and/or services. This is distinguishable from a general or context based advertisement because there is a closer correlation between content and the information. In other words, the actual golf club being used by the famous golf player in the digital media stream is the one highlighted in the information window 630. The information that is displayed in window 630 can be embedded in and extracted from the digital media content itself.

Furthermore, a pause and shop panel 635 can be displayed proximately to the window 610. The pause and shop panel 635 can include one or more icons (e.g., 640, 650) associated with each of the articles (e.g., 615, 620, 625) available for purchase. Moreover, one or more buttons (e.g., 645, 655) for purchasing the one or more articles available for purchase can be disposed near the icons. In some embodiments, each purchasing button can be associated with a corresponding one of the icons representing the article for purchase. In response to receiving input from the web browser 605 indicating that one or more button is selected for purchasing the one or more articles, the completion of the purchase can be facilitated using the one or more web servers (e.g., 235 of FIGS. 2 and 5).

In some embodiments, the pause and shop panel 635 includes a pause button 660 for pausing the digital media stream of window 610. It will be understood that the pause button can be disposed elsewhere, including within either of the windows 610 and 630. The one or more web servers (e.g., 235) can receive input from the web browser 605 indicating that the pause button 660 was selected. In response to such input, the digital media content being streamed in the window 610 can be paused. The second window 630 can be updated so that the information about the one or more articles for purchase that appear in the paused streaming digital media content is kept current. In addition, the one or more icons (e.g., 640, 650) associated with each of the one or more articles available for purchase in the pause and shop panel 635 can also be updated and kept current, depending on the articles currently appearing in the digital media content streaming window 610.

FIG. 7 illustrates a flow diagram 700 including a technique for pausing the digital media content stream and shopping for associated articles of FIG. 6. At 705, digital media content is streamed from one or more web servers (e.g., 235) to a web browser (e.g., 605). At 710, the streaming media content is displayed in a first window (e.g., 610). At 715, information about articles available for purchase that appear in the streaming media content of the first window (e.g., 610) are displayed in a second window (e.g., 630). At 730, a determination is made whether a button is selected in the pause and shop panel (e.g., 635), which displays icons representing articles shown in the digital media content stream that are available for purchase. If NO, the flow returns to step 705. Otherwise, if YES, the flow proceeds to 720, where the purchase of the selected article is facilitated using the one or more web servers (e.g., 235). It will also be understood that the steps described in these techniques need not necessarily occur in the order as illustrated.

Although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms can reference the same or different embodiments that are combinable into other embodiments.

Embodiments of the invention can include one or more tangible computer-readable media storing non-transitory computer-executable instructions that, when executed by a processor, operate to perform steps of the techniques described herein.

The following discussion is intended to provide a brief, general description of a suitable machine or machines in which certain aspects of the invention can be implemented. Typically, the machine or machines include a system bus to which is attached processors, memory, e.g., random access memory (RAM), read-only memory (ROM), or other state preserving medium, storage devices, a video interface, and input/output interface ports. The machine or machines can be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine or machines can include embedded controllers, such as programmable or non-programmable logic devices or arrays, Application Specific Integrated Circuits (ASICs), embedded computers, smart cards, and the like. The machine or machines can utilize one or more connections to one or more remote machines, such as through a network interface, modem, or other communicative coupling. Machines can be interconnected by way of a physical and/or logical network, such as an intranet, the Internet, local area networks, wide area networks, etc. One skilled in the art will appreciate that network communication can utilize various wired and/or wireless short range or long range carriers and protocols, including radio frequency (RF), satellite, microwave, Institute of Electrical and Electronics Engineers (IEEE) 545.11, Bluetooth®, optical, infrared, cable, laser, etc.

Embodiments of the invention can be described by reference to or in conjunction with associated data including functions, procedures, data structures, application programs, etc. which when accessed by a machine results in the machine performing tasks or defining abstract data types or low-level hardware contexts. Associated data can be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Other similar or non-similar modifications can be made without deviating from the intended scope of the invention. Accordingly, the invention is not limited except as by the appended claims.

1. A method for facilitating live broadcast of special events, the method comprising:
receiving an equipment rental request;
dispatching the equipment for a live special event, wherein the equipment includes at least a live media transmitter;
receiving a live digital video transmission from the live media transmitter;
watermarking the live digital video transmission; and
transmitting the watermarked live digital video transmission to one or more web servers.

2. The method of claim 1, wherein the equipment for the live special event includes a digital video camera.

3. The method of claim 2, further comprising:
after completion of the live special event, receiving the returned equipment including the digital video camera and the live media transmitter.

4. The method of claim 1, wherein the live media transmitter includes a first wireless transmitter and a second wireless transmitter, the method further comprising:
receiving a first portion of the live digital video transmission from the first wireless transmitter of the live media transmitter; and
simultaneous to receiving the first portion, receiving a second portion of the live digital video transmission from the second wireless transmitter of the live media transmitter.

5. The method of claim 4, wherein the live media transmitter includes a third wireless transmitter, the method further comprising:
simultaneous to receiving the first and second portion, receiving a third portion of the live digital video transmission from the third wireless transmitter of the live media transmitter.

6. The method of claim 5, further comprising:
detecting a failure condition of one of the first, second, and third wireless transmitters of the live media transmitter; and
in response to the failure condition, receiving the first, second, and third portions of the live digital video transmission from the other two operational wireless transmitters of the live media transmitter.

7. The method of claim 1, wherein the live digital video transmission is encrypted, the method further comprising:
decrypting the live digital video transmission prior to transmitting the live digital video transmission to the one or more web servers.

8. A method for memorializing a media content distribution agreement and delivering digital media content in accordance with the agreement, the method comprising:
initiating a video conference between a media content coordinator and a media content owner;
memorializing a media content distribution agreement, wherein memorializing includes:
recording, to a storage device, the video conference between the media content coordinator and the media content owner discussing the media content distribution agreement;
obtaining a first electronic signature from the media content coordinator authorizing the media content distribution agreement;
obtaining a second electronic signature from the media content owner authorizing the media content distribution agreement;
storing the first and second electronic signatures to a storage device; and
distributing the digital media content in accordance with the agreement.

9. The method of claim 8, further comprising:
before distributing the digital media content, receiving the digital media content from the media content owner;
watermarking the digital media content;
categorizing the watermarked digital media content into one of a plurality of categories, each category corresponding to a country or region in which the digital media content originated;
embedding the categorization information in the digital media content;
storing the watermarked and categorized digital media content to a storage device;
transmitting the watermarked and categorized digital media content to one or more web servers.

10. The method of claim 9, further comprising:
providing a user interface for a web browser, the user interface including a rotatable globe divided into countries or regions corresponding to the plurality of categories.

11. The method of claim 10, further comprising:
receiving first input from the web browser, the first input corresponding to a selection to rotate the globe;
rotating the globe in the selected direction;
receiving second input from the web browser, the second input indicating a selection of one of the countries or regions of the rotatable globe;
matching the selected country or region with the corresponding category;
displaying, in the user interface, a list of digital media content associated with the matched category.

12. The method of claim 11, further comprising:
receiving third input from the web browser, the third input corresponding to a selection of the digital media content from the list of digital media content associated with the matched category;
wherein distributing the digital media content in accordance with the agreement includes streaming the selected digital media content from the one or more web servers to the web browser in response to the selection.

13. The method of claim 8, wherein distributing the digital media content in accordance with the agreement includes streaming the digital media content from one or more web servers to a web browser.

14. The method of claim 13, further comprising:
providing a user interface for the web browser, the user interface including:
a first window for displaying the streaming digital media content;
a second window displaying information about one or more articles available for purchase that appear in the streaming digital media content of the first window;
a pause and shop panel including an icon associated with each of the articles available for purchase, and including a button for purchasing the one or more articles available for purchase;
the method further comprising:
displaying the streaming digital media content in the first window;
displaying, in the second window, the information about the one or more articles available for purchase that appear in the streaming digital media content of the first window; and
receiving input from the web browser indicating that the button for purchasing the one or more articles was selected.

15. The method of claim 14, further comprising:
responsive to receiving the input from the web browser indicating that the button for purchasing the one or more articles was selected, facilitating the completion of the purchase of the one or more articles.

16. A method for delivering digital media content, the method comprising:
streaming the digital media content from one or more web servers to a web browser;
providing a user interface for the web browser, the user interface including:
a first window for displaying the streaming digital media content;
a second window displaying information about one or more articles available for purchase that appear in the streaming digital media content of the first window;
a pause and shop panel including an icon associated with each of the articles available for purchase, and including a button for purchasing the one or more articles available for purchase;
the method further comprising:
displaying the streaming digital media content in the first window;
displaying, in the second window, the information about the one or more articles available for purchase that appear in the streaming digital media content of the first window; and
receiving input from the web browser indicating that the button for purchasing the one or more articles was selected.

17. The method of claim 16, further comprising:
responsive to receiving the input from the web browser indicating that the button for purchasing the one or more articles was selected, facilitating the completion of the purchase of the one or more articles.

18. The method of claim 16, wherein the pause and shop panel further includes a pause button, the method further comprising:
receiving second input from the web browser indicating that the pause button was selected;
pausing, in response to the second input, the streaming of the digital media content in the first window;
updating, in the second window, the information about the one or more articles available for purchase that appear in the paused streaming digital media content; and
updating the icon associated with each of the articles available for purchase in the pause and shop panel.

19. One or more tangible computer-readable media storing non-transitory computer-executable instructions that, when executed by a processor, operate to perform the method according to claim 1.
